(19) United States
(12) Patent Application Publication
(10) Pub. No.: US 2013/0011506 A1
(43) Pub. Date: Jan. 10, 2013

(54) FEEDBLOCK FOR MAKING MULTILAYERED FILMS

(76) Inventors: William T. Fay, Woodbury, MN (US); Terence D. Neavin, Saint Paul, MN (US); Robert M. Biegler, Woodbury, MN (US); William J. Kopecky, Hudson, WI (US); Daniel J. Zillig, Cottage Grove, MN (US)

(21) Appl. No.: 13/635,940

(22) PCT Filed: Mar. 3, 2011
(86) PCT No.: PCT/US11/26964

§ 371 Date: Sep. 19, 2012

Related U.S. Application Data
(60) Provisional application No. 61/317,472, filed on Mar. 25, 2010.

(51) Int. Cl. B29C 47/06

(52) U.S. Cl. 425/133.5

(57) ABSTRACT

Generally, the present description relates to a feedblock and a multilayer film die for creating polymeric multilayered films. The feedblock includes a stack of many layers of thin metal plates having flow profile cutouts, to create alternating layers of polymer.

### FIELD OF THE INVENTION

The present invention relates to a feedblock for creating polymeric multilayered films, and in particular to a feedblock that uses many layers of thin metal plates to create alternating layers of polymer.

### BACKGROUND

The present invention relates to processes and apparatuses for making polymeric multilayered films, and, for example, coextruded multilayered optical films having alternating polymeric layers with differing indices of refraction. Various process have been devised for making multilayer film structures that have an ordered arrangement of layers of various materials having particular layer thicknesses. Exemplary of these structures are those which produce an optical or visual effect because of the interaction of contiguous layers of materials having different refractive indices and layer thicknesses.

Multilayer films have previously been made or suggested to be made by the use of complex coextrusion feedblocks alone, see, for example, U.S. Pat. Nos. 3,773,882 and 3,884,606 to Schrenk, and the suggestion has been made to modify such a device to permit individual layer thickness control as described in U.S. Pat. No. 3,687,589 to Schrenk. Such modified feedblocks could be used to make a multilayer film with a desired layer thickness gradient or distribution of layer thicknesses. These devices are very difficult and costly to manufacture, and are limited in practical terms to making films of no more than about three hundred total layers. Moreover, these devices are complex to operate and not easily changed over from the manufacture of one film construction to another.

Multilayer films have also been made by a combination of a feedblock and one or more multipliers or interfacial surface generators in series, for example as described in U.S. Pat. Nos. 3,565,985 and 3,759,647 to Schrenk et al. Such a combination of a feedblock and interfacial surface generator (ISG) is more generally applicable for producing a film having a large number of layers because of the greater flexibility or adaptability and lesser manufacturing costs associated with a feedblock/ISG combination. An improved ISG for making multilayer films having a prescribed layer thickness gradient in the thicknesses of layers of one or more materials from one major surface of the film to an opposing surface was described in U.S. Pat. Nos. 5,094,788 and 5,094,793 to Schrenk et al. Schrenk described a method and apparatus in which a first stream of discrete, overlapping layers is divided into a plurality of branch streams which are redirected or repositioned and individually symmetrically expanded and contracted, the resistance to flow and thus the flow rates of each of the branch streams are independently adjusted, and the branch streams are recombined in an overlapping relationship to form a second stream which has a greater number of discrete, overlapping layers distributed in the prescribed gradient. The second stream may be symmetrically expanded and contracted as well. Multilayer films made in this way are generally extremely sensitive to thickness changes, and it is characteristic of such films to exhibit streaks and spots of nonuniform color. Further, the reflectivity of such films is highly dependent on the angle of incidence of light impinging on the film. Films made with the materials and processes heretofore described are generally not practical for uses which require uniformity of reflectivity.

To form a multilayered film, after exiting either a feedblock or a combined feedblock/ISG, a multilayered stream typically passes into an extrusion die which is constructed so that streamlined flow is maintained and the extruded product forms a multilayered film in which each layer is generally parallel to the major surface of adjacent layers. Such an extrusion device is described in U.S. Pat. No. 3,557,265 to Chisholm et al. One problem associated with microlayer extrusion technology has been flow instabilities which can occur when two or more polymers are simultaneously extruded through a die. Such instabilities may cause waviness and distortions at the polymer layer interfaces, and in severe cases, the layers may become intermixed and lose their separate identities, termed layer breakup. The importance of uniform layers, that is, layers having no waviness, distortions, or intermixing, is paramount in applications where the optical properties of the multilayered article are used.

Recent developments in materials available for use in making polymeric multilayer films, and new uses for optical films which require improved control of layer thickness and/or the relationships between the in-plane and out-of-plane indices of refraction, have been identified. Processes described heretofore typically are not able to exploit the potential of the new resins available and do not provide the required degree of versatility and control over absolute layer thickness, layer thickness gradients, indices of refraction, orientation, and interlayer adhesion that is needed for the routine manufacture of many of these films. Accordingly, there exists a need in the art for an improved process for making coextruded polymeric multilayer films, for example polymeric multilayer optical films, with greater versatility and enhanced control over several steps in the manufacturing process.

### SUMMARY

Generally, the present description relates to a feedblock for creating multilayered films, and in particular to a feedblock that uses many layers of thin metal plates to create alternating layers of polymer. In one aspect, the present disclosure provides a feedblock for making a multilayered film that includes a stack of shim subunits. Each of the shim subunits includes, in order: a first layer shim having a first flow profile cutout and a first opening; a first blocking shim having a second opening and a third opening; a second layer shim having a second flow profile cutout and a fourth opening; and a second blocking shim having a fifth opening and a sixth opening. Each of the first flow profile cutout, the second opening, the fourth opening and the fifth opening are aligned to form a first manifold, and further, each of the first opening, the third opening, the second flow profile cutout, and the sixth opening are aligned to form a second manifold separated from the first manifold.

In another aspect, the present disclosure provides a multilayer film die that includes a feedblock for making a multilayered film and an extrusion die having a die inlet aperture and a die lip. The feedblock further includes a stack of shim subunits, each of the shim subunits including, in order: a first layer shim having a first flow profile cutout and a first opening; a first blocking shim having a second opening and a third opening; a second layer shim having a second flow profile cutout and a fourth opening; and a second blocking shim having a fifth opening and a sixth opening. Each of the first flow profile cutout, the second opening, the fourth opening and the fifth opening are aligned to form a first manifold, and each of the first opening, the third opening, the second flow profile cutout, and the sixth opening are aligned to form a second manifold separated from the first manifold. The feedblock and the extrusion die are disposed so that the feedblock exit aperture is adjacent the die inlet aperture.

In another aspect, the present disclosure provides a feedblock for making a multilayered film that includes a stack of shim subunits, each of the shim subunits including, in order: a first layer shim having a first inlet and a first flow profile cutout; a first blocking shim; a second layer shim having a second inlet and a second flow profile cutout; and a second blocking shim. The feedblock for making a multilayered film further includes a gradient plate having a first manifold aligned to each first inlet, and a second manifold aligned to each second inlet, wherein the first manifold and second manifold lack fluid communication.

The above summary is not intended to describe each disclosed embodiment or every implementation of the present disclosure. The figures and the detailed description below more particularly exemplify illustrative embodiments.

### BRIEF DESCRIPTION OF THE DRAWINGS

Throughout the specification reference is made to the appended drawings, where like reference numerals designate like elements, and wherein:

FIG. 1 is a schematic of a multilayer film process;

FIG. 2A is a perspective schematic of a feedblock;

FIG. 2B is a top view of the first layer shim of FIG. 2A;

FIG. 2C is a top view of the second layer shim of FIG. 2A;

FIG. 2D is a top view of the blocking shim of FIG. 2A;

FIG. 2E is perspective view showing the assembly of the stack of FIG. 2A;

FIG. 3A is a perspective schematic of a feedblock;

FIG. 3B is a top view of the first layer shim of FIG. 3A;

FIG. 3C is a top view of the second layer shim of FIG. 3A;

FIG. 3D is a top view of the blocking shim of FIG. 3A;

FIG. 3E is perspective view showing the assembly of the stack of FIG. 3A;

FIG. 4A is a perspective view of a monolithic first layer shim; and

FIG. 4B is a perspective view of a monolithic second layer shim.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

Various process considerations are important in making high quality polymeric multilayer films, polymeric multilayer optical films, and other optical devices in accordance with the present invention. Such films include, but are not limited to, optical films such as interference polarizers, mirrors, colored films, and combinations thereof. The films are optically effective over diverse portions of the ultraviolet, visible, and infrared spectra. Of particular interest are coextruded polymeric multilayer optical films having one or more layers that are birefringent in nature. The process conditions used to make each depends in part on (1) the particular resin system used and (2) the desired optical properties of the final film.

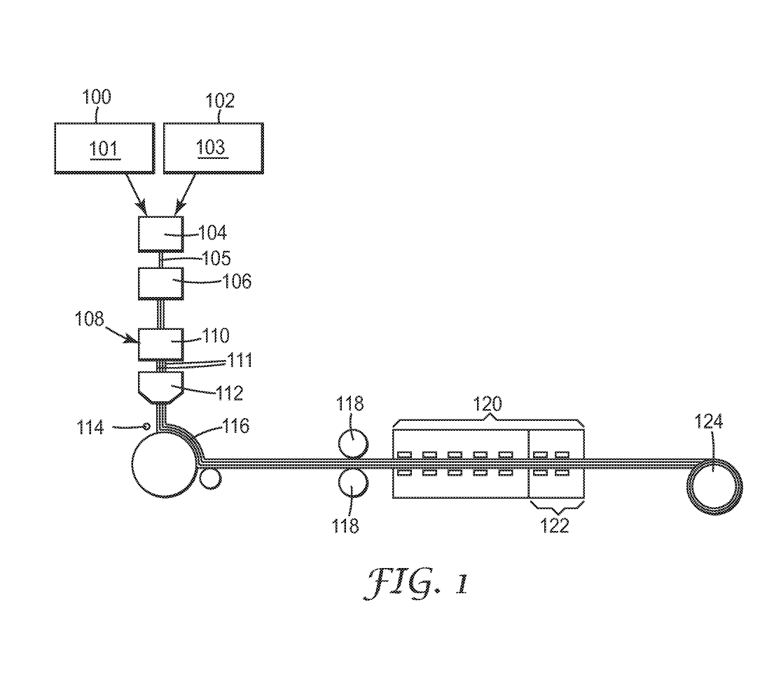

A preferred method of making a multilayer film such as a multilayer optical film has been described elsewhere, for example, in U.S. Pat. No. 6,783,349 (Neavin et al.), and is illustrated schematically in FIG. 1. Materials 100 and 102, selected to have suitably different optical properties, are heated above their melting and/or glass transition temperatures and fed into a multilayer feedblock 104. Typically, melting and initial feeding is accomplished using an extruder for each material. For example, material 100 can be fed into an extruder 101 while material 102 can be fed into an extruder 103. Exiting from the feedblock 104 is a multilayer flow stream 105. A layer multiplier 106 splits the multilayer flow stream, and then redirects and “stacks” one stream atop the second to multiply the number of layers extruded. An asymmetric multiplier, when used with extrusion equipment that introduces layer thickness deviations throughout the stack, may broaden the distribution of layer thicknesses so as to enable the multilayer film to have layer pairs corresponding to a desired portion of the spectrum of light, and provide a desired layer thickness gradient. If desired, skin layers 111 may be introduced into the multilayer optical film by feeding resin 108 (for skin layers) to a skin layer feedblock 110.

The multilayer feedblock feeds a film extrusion die 112. Examples of feedblocks are described in, for example, U.S. Pat. No. 3,773,882 (Schrenk) and U.S. Pat. No. 3,884,606 (Schrenk). As an example, the extrusion temperature may be approximately 295 degrees C. and the feed rate approximately 10-150 kg/hour for each material. It is desirable in most cases to have skin layers 111 flowing on the upper and lower surfaces of the film as it goes through the feedblock and die. These layers serve to dissipate the large stress gradient found near the wall, leading to smoother extrusion of the optical layers. Typical extrusion rates for each skin layer would be 2-50 kg/hr (1-40% of the total throughput). The skin material can be the same material as one of the optical layers or be a different material. An extrudate leaving the die is typically in a melt form.

The extrudate is cooled on a casting wheel 116, which rotates past pinning wire 114. The pinning wire pins the extrudate to the casting wheel. To achieve a clear film over a broad range of angles, one can make the film thicker by running the casting wheel at a slow speed, which moves the reflecting band towards longer wavelengths. The film is oriented by stretching at ratios determined by the desired optical and mechanical properties. Longitudinal stretching can be done by pull rolls 118. Transverse stretching can be done in a tenter oven 120. If desired, the film can be bi-axially oriented simultaneously. Stretch ratios of approximately 3-4 to 1 are preferred, although ratios as small as 2 to 1 and as large as 6 to 1 may also be appropriate for a given film. Stretch temperatures will depend on the type of birefringent polymer used, but 2 to 33 degrees C. (5 to 60 degrees F.) above its glass transition temperature would generally be an appropriate range. The film is typically heat set in the last two zones 122 of the tenter oven to impart the maximum crystallinity in the film and reduce its shrinkage. Employing a heat set temperature as high as possible without causing film breakage in the tenter reduces the shrinkage during a heated embossing step. A reduction in the width of the tenter rails by about 1-4% also serves to reduce film shrinkage. If the film is not heat set, heat shrink properties are maximized, which may be desirable in some security packaging applications. The film can be collected on windup roll 124.

In some applications, it may be desirable to use more than two different polymers in the optical layers of the multilayer film. In such a case, additional resin streams can be fed using similar means to resin streams 100 and 102. A feedblock appropriate for distributing more than two layer types analogous to the feedblock 104 could be used.

The process used for making coextruded polymeric multilayer films, such as polymeric multilayer optical films of the present invention, will vary depending on the resin materials selected and the optical properties desired in the finished film product.

Moisture sensitive resins should be dried before or during extrusion to prevent degradation. The drying can be done by any means known in the art. One well-known means employs ovens or more sophisticated heated vacuum and/or desiccant hopper-dryers to dry resin prior to its being fed to an extruder. Another means employs a vacuum-vented twin-screw extruder to remove moisture from the resin while it is being extruded. Drying time and temperature should be limited to prevent thermal degradation or sticking during hopper-dryer or oven drying. In addition, resins coextruded with moisture sensitive resins should be dried to prevent damage to the moisture sensitive coextruded resin from moisture carried by the other resin.

Extrusion conditions are chosen to adequately feed, melt, mix and pump the polymer resin feed streams in a continuous and stable manner. Final melt stream temperatures are chosen within a range which avoids freezing, crystallization or unduly high pressure drops at the low end of the temperature range and which avoids degradation at the high end of the temperature range.

It is often preferable for all polymers entering the multilayer feedblock to be at the same or very similar melt temperatures. This may require process compromise if two polymers, whose ideal melt processing temperatures do not match, are to be coextruded.

Following extrusion, the melt streams are then filtered to remove undesirable particles and gels. Primary and secondary filters known in the art of polyester film manufacture may be used, with mesh sizes in the 1-30 micrometer range. While the prior art indicates the importance of such filtration to film cleanliness and surface properties, its significance in the present invention extends to layer uniformity as well. Each melt stream is then conveyed through a neck tube into a gear pump used to regulate the continuous and uniform rate of polymer flow. A static mixing unit may be placed at the end of the neck tube carrying the melt from the gear pump into the multilayer feedblock, in order to ensure uniform melt stream temperature. The entire melt stream is heated as uniformly as possible to ensure both uniform flow and minimal degradation during processing.

Multilayer feedblocks are designed to divide two or more polymer melt streams into many layers each, interleave these layers, and merge the many layers of two or more polymers into a single multilayer stream. The layers from any given melt stream are created by sequentially bleeding off part of the stream from a flow channel into side channel tubes that feed layer slots for the individual layers in the feedblock. Many designs are possible, including those disclosed in U.S. Pat. Nos. 3,737,882; 3,884,606; and 3,687,589 to Schrenk et al. Methods have also been described to introduce a layer thickness gradient by controlling layer flow as described in U.S. Pat. Nos. 3,195,865; 3,182,965; 3,051,452; 3,687,589 and 5,094,788 to Schrenk et al, and in U.S. Pat. No. 5,389,324 to Lewis et al. In typical industrial processes, layer flow is generally controlled by choices made in machining the shape and physical dimensions of the individual side channel tubes and layer slots.

In some cases, a modular design that requires only a few sections of the feedblock to be machined for each unique film construction, as described, for example, in U.S. Pat. No. 6,783,349 (Neavin et al.). The economic advantage of the modular design can be a reduction in time, labor, and equipment needed to change from one film construction to another.

Typical feedblocks currently used in production of multi-layered film are constructed using a stack of several thick plates with features machined into them. This type of feedblock is robust in design, and a typical current feedblock has, for example, one layer per 0.168″ (4.27 mm) of width, resulting in a very large assembly, with a weight over approximately 3,300 pounds (1500 kg). The typical current feedblocks are also expensive to fabricate, and as such are not well suited for short duration, rapid changeover lab experiments. For example, to change the layer count or configuration, costly new slot plates must be fabricated and can require hundreds of hours of machining. The massive size of the feedblock also requires additional infrastructure to support the feedblock in operation and also to hold it during assembly and cleaning. The dimensions and surface finish within the machined slots are also challenging to quantify, and the location of the machining start and stop points within the slots can create artifacts within the finished film.

In one particular embodiment, the present disclosure allows a high density of layers, for example, one layer per 0.030″ (0.76 mm) of width, resulting in a feedblock about one fifth of the width of the current feedblock configurations. In one contemplated embodiment, a complete feedblock could be relatively small, and weigh about 300 pounds—about about a tenth of the weight of a typical current feedblock. This multilayer feedblock could be mounted on the back of a film die without requiring any additional support structure. This may allow production of multi-layered film on smaller film lines not traditionally used for this purpose.

The thin shims that comprise the feedblock are inexpensive to fabricate, and can be reconfigured inexpensively and quickly, with a new set of shims laser cut within a few days. This could be a great benefit to new product development, allowing new configurations to be rapidly tested at nominal cost. In some cases, these inexpensive feedblocks can also be used to process materials that are either difficult to clean from a feedblock, or are corrosive or otherwise damaging to the feedblock. The slots in the disclosed feedblock are formed by a stack of flat shims, so the surface finish within the slots can be easily determined by measuring the finish on the plates before assembling the stack. Any artifacts created by the profiled shim, which forms the thickness of the layer, will be confined to the edges of the film and discarded as edge trim. The thickness of the profiled shims can be readily measured with a micrometer.

It is to be understood that although the term “shim” is used herein, the term “plate” can equally be used. Often, “shim” designates thinner material than “plate”, such as shim material being generally less than about 0.030 inches (about 0.76 mm), and plate material being generally greater than about 0.100 inches (about 2.54 mm). It is to be understood that either shims or plates can be used in the practice of the invention described herein, and the disclosure is not to be limited by the thickness or thinness of the individual shims comprising the feedblock.

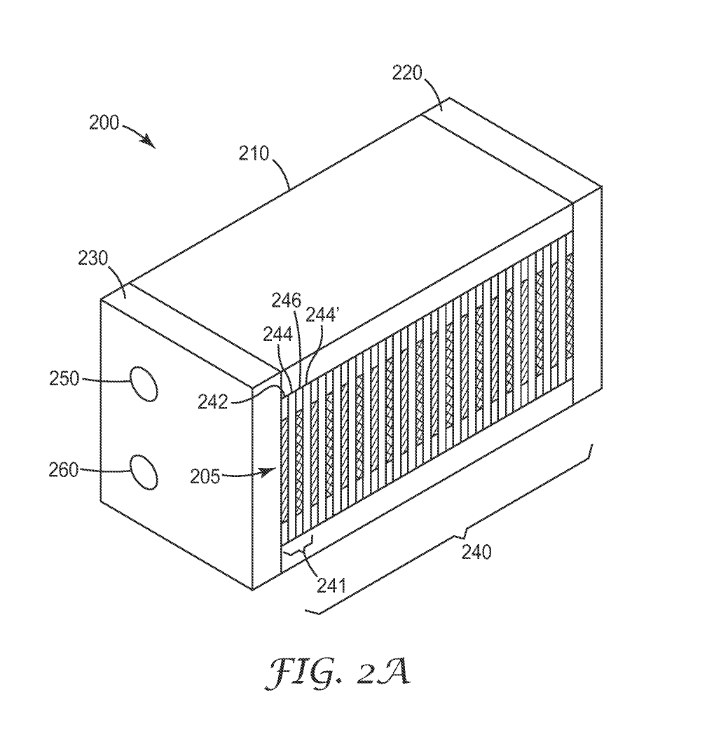

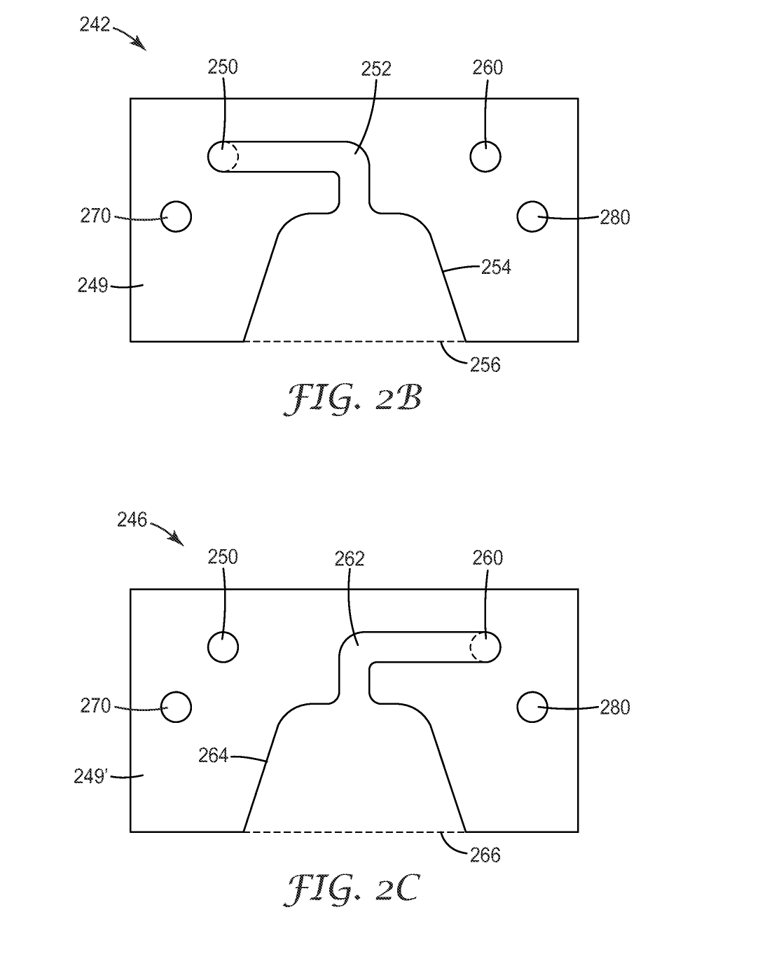

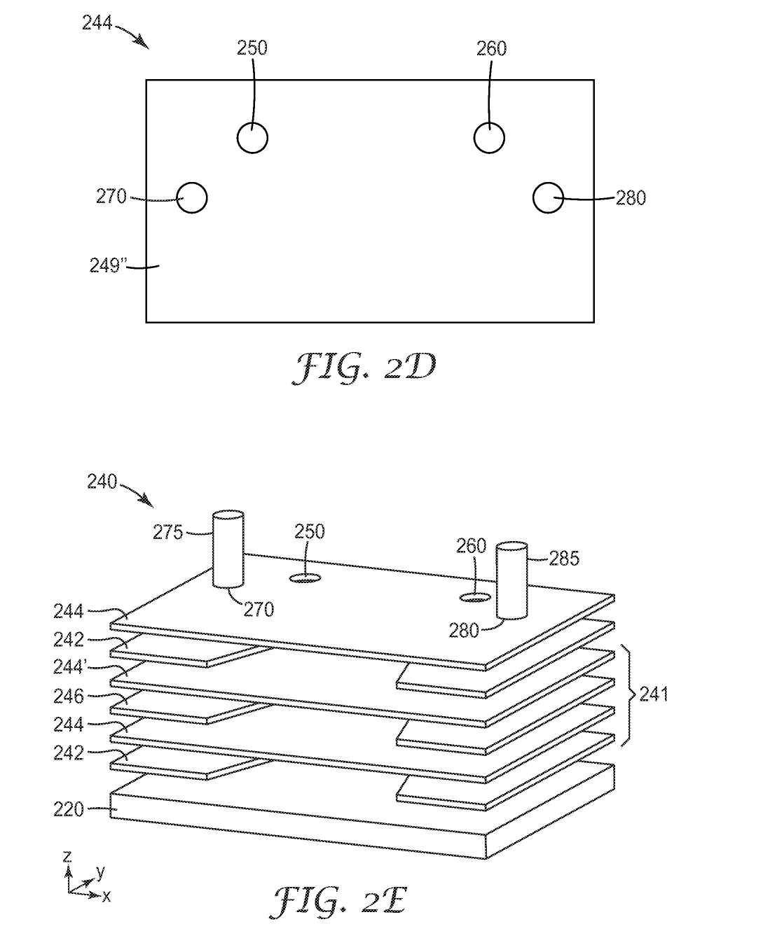

FIG. 2A is a schematic perspective view of a feedblock 200 for making a multilayered film, according to one aspect of the disclosure. Feedblock 200 includes a feedblock housing 210 that includes a stack 240 of shim subunits 241 disposed between a first end plate 220 and a second end plate 230 of the feedblock housing 210. The stack 240 of shim subunits 241 collectively form an exit aperture 205 of the feedblock 200. A first manifold inlet 250 and a second manifold inlet 260 are provided in at least one of the first end plate 220 and the second end plate 230. In one particular embodiment, each of the shim subunits 241 include, in order, a first layer shim 242, a first blocking shim 244, a second layer shim 246, and a second blocking shim 244′. In some cases, the shim subunits 241 are stacked on top of each other to form an alternating arrangement of first and second layer shims 242, 246, separated by blocking shims 244, 244′.

Each of the first layer shim 242, the first and the second blocking shims 244, 244′, and the second layer shim 246 can be made from a thin metal sheet, such as from sheet aluminum, brass, copper, steel, and the like. In one particular embodiment, steel shims such as stainless steel shims may be preferred. The thickness of each of the shims can independently range from about 0.005″ (0.127 mm) or less, up to about 0.030″ (0.762 mm) or more. In some cases, for example, the thickness of the shims can independently range from about 0.01 mm to about 3.0 mm or more, or from about 0.05 mm to about 2.0 mm or more, or from about 0.1 mm to about 1.0 mm, or from about 0.13 mm to about 0.76 mm. In some cases, each of the first layer shims 242 are the same thickness across the length of the exit aperture 205, each of the second layer shims 246 are the same thickness across the length of the exit aperture 205, and each of the first and second blocking shims 244, 244′ are the same thickness across the length of the exit aperture 205. In some cases, each of the shims can vary uniformly or non-uniformly in thickness across the length of the exit aperture 205. A variation in shim thickness across the length of the exit aperture can be useful for producing specific optical effects in the finished multilayer film, as described elsewhere.

FIG. 2B is a schematic view of the first layer shim 242 within the shim subunit 241 of FIG. 2A, according to one aspect of the disclosure. First layer shim 242 includes a first flow profile cutout 252 and a first opening 260 that can be cut from a first metal sheet 249. First flow profile cutout 252 forms a connection between first manifold 250 and a first exit orifice 256. First flow profile cutout 252 can have a first profile boundary 254 that is formed by cutting first metal sheet 249 by any known technique including, for example, laser cutting, die cutting, wire EDM (electrical discharge machining), chemical etching, and the like. In some cases, laser cutting can be a preferred cutting technique. First metal sheet 249 and first profile boundary 254 can be finished to any desired degree of smoothness, however highly polished surfaces are preferred. First layer shim 242 further includes optional first and second alignment features 270, 280 which can be used to precisely position first layer shim 242 during stacking into shim subunit 241 and stack of shim subunits 240. Alignment features can be any desired shape that allows the precise placement and registration of the shims in the stack, including, for example, circles, ovals, triangles, squares and the like. In some cases, circles are preferred alignment features.

FIG. 2C is a schematic view of the second layer shim 246 within the shim subunit 241 of FIG. 2A, according to one aspect of the disclosure. Second layer shim 246 includes a second flow profile cutout 262 and a second opening 250 that can be cut from a second metal sheet 249′. First and second metal sheets 249, 249′ can be fabricated from the same material and have the same thickness, or they can be different. Second flow profile cutout 262 forms a connection between second manifold 260 and a second exit orifice 266. Second flow profile cutout 262 can have a second profile boundary 264 that is formed by cutting second metal sheet 249′ by any known technique including, for example, laser cutting, die cutting, wire EDM, chemical etching, and the like. In some cases, laser cutting can be a preferred cutting technique. Second metal sheet 249′ and second profile boundary 264 can be finished to any desired degree of smoothness, however highly polished surfaces are preferred. Second layer shim 246 further includes optional first and second alignment features 270, 280 which can be used to precisely position second layer shim 246 during stacking into shim subunit 241 and stack of shim subunits 240.

In one particular embodiment, first layer shim 242 and second layer shim 246 can be mirror images of each other, for example, as shown in FIGS. 2B-2C. In this embodiment, the relative positions of the first manifold 250, second manifold 260 and optional first and second alignment features are disposed such that the first layer shim 242 can be flipped over to form the second layer shim 246.

FIG. 2D is a schematic view of the first blocking shim 244 within the shim subunit 241 of FIG. 2A, according to one aspect of the disclosure. First blocking shim 244 includes first manifold 250 and second manifold 260, and optional first and second alignment features 270, 280. As shown in FIG. 2A, each of the stack subunits may include the first blocking shim 244 and a second blocking shim 244′, that can be fabricated from the same metal sheet 249″ and have the same thickness, or they can be different. In one particular embodiment, the first blocking shim 244 and the second blocking shim 244′ are identical.

FIG. 2E is a perspective view showing the assembly of the stack 240 of the feedblock 200 of FIG. 2A, according to one aspect of the disclosure. A first alignment post 275 and a second alignment post 285 are positioned in first end plate 220. Shims are stacked in an alternating manner, on first end plate 220 such that first alignment feature 270 and second alignment feature 280 are positioned on first and second alignment posts 275, 285, respectively. As shown in FIG. 2E, the stack 240 is formed by sequencing first layer shim 242, first blocking shim 244, second layer shim 246, and second blocking shim 244′ to form shim subunit 241, and continuing the stacking process to form the desired stack 240 in feedblock 200. A compressive force is applied in the “z” direction of the stack, and the second end plate 230 is affixed forming the feedblock 200. In FIG. 2E, the shims are precisely located using, for example, metal posts. In one particular embodiment, for example starting at one end, 275 polymer shims and 275 blocker shims are alternately stacked, and then contained by securing the second endplate. The resulting multilayered melt stream is fed into a compression section and attached to the back of a die.

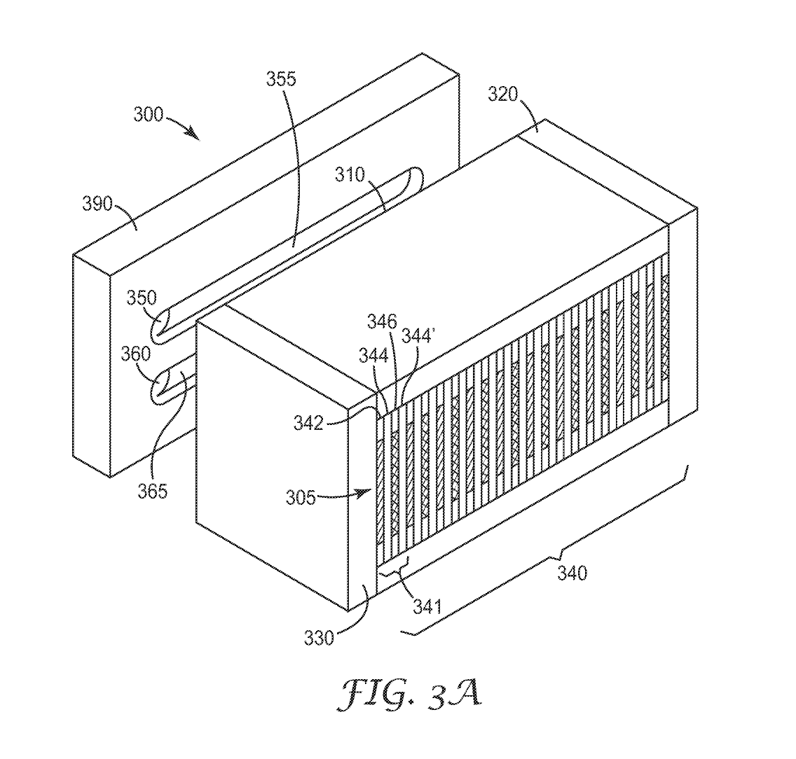

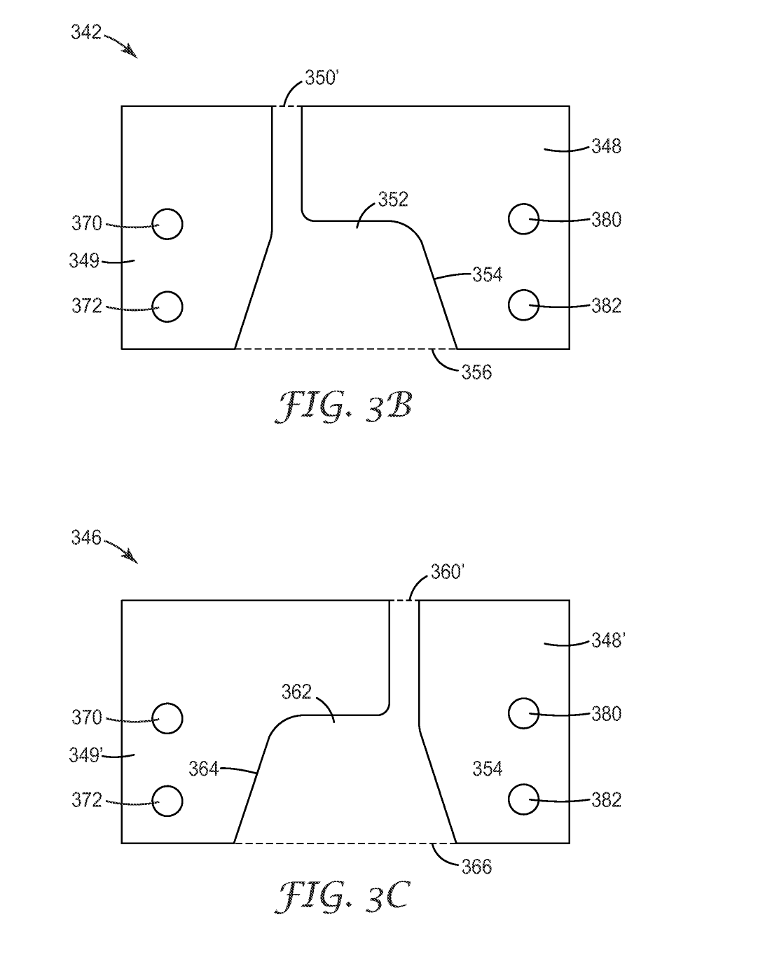

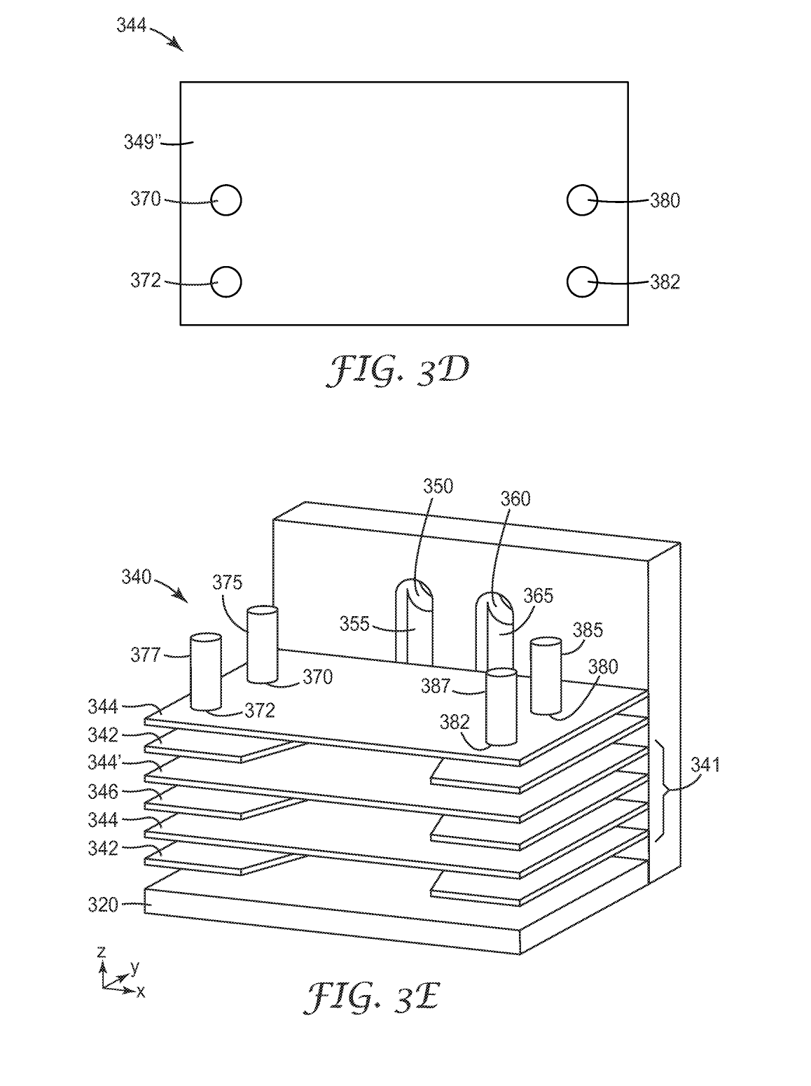

FIG. 3A is a schematic perspective view of a feedblock 300 for making a multilayered film, according to one aspect of the disclosure. Feedblock 300 includes a feedblock housing 310 that includes a stack 340 of shim subunits 341 disposed between a first end plate 320 and a second end plate 330 of the feedblock housing 310. The stack 340 of shim subunits 341 collectively form an exit aperture 305 of the feedblock 300. In one particular embodiment, each of the shim subunits 341 include, in order, a first layer shim 342, a first blocking shim 344, a second layer shim 346, and a second blocking shim 344′. In some cases, the shim subunits 341 are stacked on top of each other to form an alternating arrangement of first and second layer shims 342, 346, separated by blocking shims 344, 344′.

A first manifold inlet 350 and a second manifold inlet 360 are provided in a gradient plate 390, which is attached to feedblock housing 310 (shown to be detached from feedblock housing 310 in FIG. 3A, for clarity). The first manifold inlet 350 is in fluid communication with a first manifold 355, and the second manifold inlet 360 is in fluid communication with a second manifold 365. The first manifold 355 and the second manifold 365 lack fluid communication with each other, that is, material streams in each of the manifolds remain separated.

Each of the first layer shim 342, the first and the second blocking shims 344, 344′, and the second layer shim 346 can be made from a thin metal sheet, such as from sheet aluminum, brass, copper, steel, and the like. In one particular embodiment, steel shims such as stainless steel shims may be preferred. The thickness of each of the shims can independently range from about 0.005″ (0.127 mm) or less, up to about 0.030″ (0.762 mm) or more. In some cases, for example, the thickness of the shims can independently range from about 0.01 mm to about 3.0 mm or more, or from about 0.05 mm to about 2.0 mm or more, or from about 0.1 mm to about 1.0 mm, or from about 0.13 mm to about 0.76 mm. In some cases, each of the first layer shims 342 are the same thickness across the length of the exit aperture 305, each of the second layer shims 346 are the same thickness across the length of the exit aperture 305, and each of the first and second blocking shims 344, 344′ are the same thickness across the length of the exit aperture 305. In some cases, each of the shims can vary uniformly or non-uniformly in thickness across the length of the exit aperture 305. A variation in shim thickness across the length of the exit aperture can be useful for producing specific optical effects in the finished multilayer film, as described elsewhere.

FIG. 3B is a schematic view of the first layer shim 342 within the shim subunit 341 of FIG. 3A, according to one aspect of the disclosure. First layer shim 342 includes a first flow profile cutout 352 and a first shim manifold inlet 350′ that can be cut from a first metal sheet 349. First metal sheet 349 can be separated into a second first metal sheet part 348 as shown in FIG. 3B. First flow profile cutout 352 forms a connection between first shim manifold inlet 350′ and a first exit orifice 356. First flow profile cutout 352 can have a first profile boundary 354 that is formed by cutting first metal sheet 349 by any known technique including, for example, laser cutting, die cutting, wire EDM (electrical discharge machining), chemical etching, and the like. In some cases, laser cutting can be a preferred cutting technique. First metal sheet 349 and first profile boundary 354 can be finished to any desired degree of smoothness, however highly polished surfaces are preferred.

First layer shim 342 further includes optional first and second alignment features 370, 380, and optional third and fourth alignment features 372, 382, which can be used to precisely position first layer shim 342 during stacking into shim subunit 341 and stack of shim subunits 340. In some cases, at least four alignment features may be used to ensure proper alignment, for example, two alignment features may be used for each of the pieces 349, 348 of first layer shim 342, as shown in FIG. 3B. In some cases, only two alignment features may be used, for example, when the first layer shim and first blocking shim are bonded together or monolithic, as described elsewhere. Alignment features can be any desired shape that allows the precise placement and registration of the shims in the stack, including, for example, circles, ovals, triangles, squares and the like. In some cases, circles are preferred alignment features.

FIG. 3C is a schematic view of the second layer shim 346 within the shim subunit 341 of FIG. 3A, according to one aspect of the disclosure. Second layer shim 346 includes a second flow profile cutout 362 and a second shim manifold inlet 360′ that can be cut from a second metal sheet 349′. Second metal sheet 349′ can be separated into a second second metal sheet part 348′ as shown in FIG. 3C. First and second metal sheets 349, 349′ can be fabricated from the same material and have the same thickness, or they can be different. Second flow profile cutout 362 forms a connection between second shim manifold inlet 360′ and a second exit orifice 366. Second flow profile cutout 362 can have a second profile boundary 364 that is formed by cutting second metal sheet 349′ by any known technique including, for example, laser cutting, die cutting, wire EDM, chemical etching, and the like. In some cases, laser cutting can be a preferred cutting technique. Second metal sheet 349′ and second profile boundary 364 can be finished to any desired degree of smoothness, however highly polished surfaces are preferred.

Second layer shim 346 further includes optional first and second alignment features 370, 380, and optional third and fourth alignment features 372, 382, which can be used to precisely position second layer shim 346 during stacking into shim subunit 341 and stack of shim subunits 340. In some cases, at least four alignment features may be used to ensure proper alignment, for example, two alignment features may be used for each of the pieces 349′, 348′ of second layer shim 346, as shown in FIG. 3C. In some cases, only two alignment features may be used, for example, when the first layer shim and first blocking shim are bonded together or monolithic, as described elsewhere. Alignment features can be any desired shape that allows the precise placement and registration of the shims in the stack, including, for example, circles, ovals, triangles, squares and the like. In some cases, circles are preferred alignment features.

In one particular embodiment, first layer shim 342 and second layer shim 346 can be mirror images of each other, for example, as shown in FIGS. 3B-3C. In this embodiment, the relative positions of the first shim manifold inlet 350′, second shim manifold inlet 360′ and optional alignment features are disposed such that the first layer shim 342 can be flipped over to form the second layer shim 346.

FIG. 3D is a schematic view of the first blocking shim 344 within the shim subunit 341 of FIG. 3A, according to one aspect of the disclosure. First blocking shim 344 includes optional first and second alignment features 370, 380, and optional third and fourth alignment features 372, 382. As shown in FIG. 3A, each of the stack subunits may include the first blocking shim 344 and a second blocking shim 344′, that can be fabricated from the same metal sheet 349″ and have the same thickness, or they can be different. In one particular embodiment, the first blocking shim 344 and the second blocking shim 344′ are identical.

FIG. 3E is a perspective view showing the assembly of the stack 340 of the feedblock 300 of FIG. 3A, according to one aspect of the disclosure. A first alignment post 375 and a second alignment post 385 are positioned in first endplate 320. Optional third alignment post 377 and optional fourth alignment post 387 can also be positioned in first endplate 320. Shims are stacked in an alternating manner, on first end plate 320 such that first alignment feature 370 and second alignment feature 380 are positioned on first and second alignment posts 375, 385, respectively, and that optional third alignment feature 372 and optional fourth alignment feature 382 are positioned on optional third and optional fourth alignment posts 377, 387, respectively.

As shown in FIG. 3E, the stack 340 is formed by sequencing first layer shim 342, first blocking shim 344, second layer shim 346, and second blocking shim 344′ to form shim subunit 341, and continuing the stacking process to form the desired stack 340 in feedblock 300. The gradient plate 390 is then positioned such that the first manifold 355 aligns with each of the first shim manifold inlets 350′ in each of the first layer shims 342, and the second manifold 365 aligns with each of the second shim manifold inlets 360′ in each of the second layer shims 346. A compressive force is applied in both the “y” and “z” direction of the stack, and the second endplate 330 is affixed forming the feedblock 300. In FIG. 3E, the shims are precisely located using, for example, metal posts. In one particular embodiment, for example starting at one end, 275 polymer shims and 275 blocker shims are alternately stacked, and then contained by securing the second endplate. The resulting multilayered melt stream is fed into a compression section and attached to the back of a die.

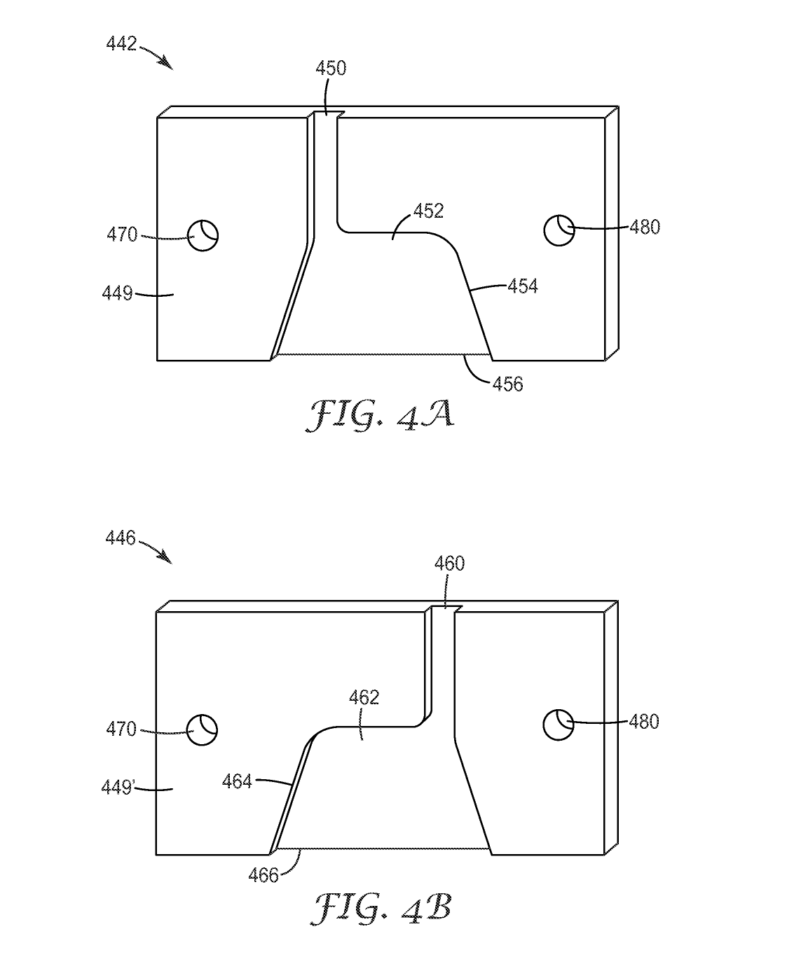

FIG. 4A is a perspective view of a monolithic first layer shim 442, according to one aspect of the disclosure. In one particular embodiment, monolithic first layer shim 442 can include a blocking layer, such as, for example, a blocking shim that has been bonded to a first layer shim, as described elsewhere. Bonding can be accomplished by any known technique including, for example, welding, induction welding, soldering, and the like. In one particular embodiment, the monolithic first layer shim 442 can be machined directly from a plate, leaving a blocking layer of material that serves as a blocking shim, between adjacent stacked layer shims.

Monolithic first layer shim 442 includes a first flow profile cutout 452 that can be cut from a first metal sheet 449. First flow profile cutout 452 forms a connection between first manifold 450 and a first exit orifice 456. First flow profile cutout 452 can have a first profile boundary 454 that is formed by cutting first metal sheet 449 by any known technique including, for example, laser cutting, die cutting, milling, wire EDM (electrical discharge machining), chemical etching, and the like. First metal sheet 449 and first profile boundary 454 can be finished to any desired degree of smoothness, however highly polished surfaces are preferred. Monolithic first layer shim 442 further includes optional first and second alignment features 470, 480 which can be used to precisely position first layer shim 442 during stacking as described elsewhere. Alignment features can be any desired shape that allows the precise placement and registration of the shims in the stack, including, for example, circles, ovals, triangles, squares and the like. In some cases, circles are preferred alignment features.

FIG. 4B is a perspective view of a monolithic second layer shim 446, according to one aspect of the disclosure. In one particular embodiment, monolithic first layer shim 446 can include a blocking layer, such as, for example, a blocking shim that has been bonded to a first layer shim, as described elsewhere. Bonding can be accomplished by any known technique including, for example, welding, induction welding, soldering, and the like. In one particular embodiment, the monolithic second layer shim 446 can be machined directly from a plate, leaving a blocking layer of material that serves as a blocking shim, between adjacent stacked layer shims.

Monolithic second layer shim 446 includes a second flow profile cutout 462 that can be cut from a second metal sheet 449′. Second flow profile cutout 462 forms a connection between second manifold 460 and a second exit orifice 466. Second flow profile cutout 462 can have a second profile boundary 464 that is formed by cutting second metal sheet 449′ by any known technique including, for example, laser cutting, die cutting, milling, wire EDM (electrical discharge machining), chemical etching, and the like. Second metal sheet 449′ and second profile boundary 464 can be finished to any desired degree of smoothness, however highly polished surfaces are preferred. Monolithic second layer shim 446 further includes optional first and second alignment features 470, 480 which can be used to precisely position second layer shim 446 during stacking as described elsewhere. Alignment features can be any desired shape that allows the precise placement and registration of the shims in the stack, including, for example, circles, ovals, triangles, squares and the like. In some cases, circles are preferred alignment features. First and second monolithic layer shims 442, 446, can be stacked to form a multilayer feedblock in manner similar to that shown with reference to FIGS. 2A-2E and 3A-3E, as would be apparent to one of skill in the art.

It is to be understood that each of the layer shims described above can include more than one flow profile cutout, for example, to form a tandem manifold that can produce two different layer distributions, which could be combined together to form the finished layer stack. Also, in one particular embodiment, each of the shims can be welded, soldered, or otherwise bonded to each other to form a monolithic feedblock stack. Such a monolithic feedblock may be desireable to prevent cross-contamination of materials due to distortion at processing pressures; however, in this embodiment, disassembly of the feedblock may not be possible.

Along each of the first and second manifolds 250, 260 of the multilayer feedblock 200, the cross-sectional area can remain constant or can change. The change may be an increase or decrease in area, and a decreasing cross-section is typically referred to as a “taper.” A change in cross-sectional area of the manifolds can be designed to provide an appropriate pressure gradient, which affects the layer thickness distribution of a multilayer film, such as a multilayer optical film. In one particular embodiment, the cross sectional area within each of the first and second manifolds 250, 260 can be cut to a taper after assembly of the stack 240, using, for example a wire EDM technique, as known in the art. Thus, the multilayer feedblock can be changed for different types of multilayer film constructions.

In use, polymeric resins, in the form of a melt stream, are delivered to the first and second manifolds 250, 260, from a source, such as an extruder. Typically, a different resin is delivered to each manifold. For example, resin A is delivered to first manifold 250 and resin B is delivered to second manifold 260 as two distinct melt streams. As the melt stream A and melt stream B travel down the flow channels in the “z” direction, each melt stream is bled off by the first and second flow profile cutouts 252, 262, respectively. Because the first and second flow profile cutouts 252, 262 are interleaved, they begin the formation of alternating layers, such as, for example, ABABAB. Each of the first and second flow profile cutouts 252, 262 has its own exit orifice 256, 266, respectively, to begin the formation of an actual layer. The melt stream exiting the exit aperture 205 contains a plurality of alternating layers. The melt stream is fed into a compression section (not shown) where the layers are compressed and also uniformly spread out transversely.

Special thick layers known as protective boundary layers (PBLs) may be fed nearest to the multilayer feedblock walls from any of the melt streams used for the multilayer stack. The PBLs can also be fed by a separate feed stream after the feedblock. The PBLs function to protect the thinner layers, such as thin optical layers in a multilayer optical film, from the effects of wall stress and possible resulting flow instabilities.

The multilayer feedblocks and the film-making processes using the multilayer feedblocks described herein can be used for optical or non-optical applications. Optical applications are typically the most demanding to process, and are therefore used in the descriptions to follow. It is to be understood, however, that the feedblocks and processes can equally be directed to non-optical multilayered films.

In optical applications, especially for films intended to transmit or reflect a specific color(s) or wavelength of light, very precise layer thickness uniformity in the film plane is required. Perfect layer uniformity following a transverse spreading step, occurring in the slot die, is difficult to achieve in practice. The greater the amount of transverse spreading required, the higher the likelihood of non-uniformity in the resulting layer thickness profile. Thus, it is advantageous from the standpoint of layer thickness profile uniformity (or for film color uniformity) for the feedblock's slot die to be relatively wide. However, increasing the widths of the slot die results in a larger, heavier, and more expensive feedblock. It will be apparent that an assessment of the optimal slot widths must be made individually for each feedblock case, taking into consideration the optical uniformity requirements of the resulting film. This assessment can be done using reliable rheological data for the polymer in question and polymer flow simulation software known in the art, along with a model for feedblock fabrication costs.

A modular feedblock of the type described herein, having a plurality of layer shims adaptable to vary the thickness of individual layer thicknesses or layer thickness profiles without necessitating changing or re-machining the entire feedblock assembly, is especially useful for modifying layer thickness profiles as described above.

The various layers in the film preferably have different thicknesses across the film. This is commonly referred to as the layer thickness gradient. A layer thickness gradient is selected to achieve the desired band width of reflection in an optical film. One common layer thickness gradient is a linear one, in which the thickness of the thickest layer pairs is a certain percent thicker than the thickness of the thinnest layer pairs. For example, a 1.055:1 layer thickness gradient means that the thickest layer pair (adjacent to one major surface) is 5.5% thicker than the thinnest layer pair (adjacent to the opposite surface of the film). In another embodiment, the layer thickness could decrease, increase, and decrease again from one major surface of the film to the other. This is believed to provide sharper bandedges, and thus a sharper or more abrupt transition from reflective to transmissive regions of the spectrum. This preferred method for achieving sharpened bandedges is described more fully in U.S. Pat. No. 6,157,490 (Wheatley et al.) entitled “Optical Film with Sharpened Bandedge” filed Jan. 13, 1998.

The method of achieving sharpened band edges will be briefly described for a multilayer film having layers arranged in an alternating sequence of two optical materials, “A” and “B”. Three or more distinct optical materials can be used in other embodiments. Each pair of adjacent “A” and “B” layers make up an optical repeating unit (ORU), beginning at the top of the film with ORU1 and ending with ORU6, with the ORUs having optical thicknesses OT.sub.1, OT.sub.2, . . . OT.sub.6. For maximum first order reflectance (M=1 in equation 1) at a design wavelength, each of the ORUs should have a 50% f-ratio with respect to either the A or B layer. The A layers can be considered to have a higher X- (in-plane) refractive index than the B layers because the former are shown to be thinner than the latter. ORUs 1-3 may be grouped into a multilayer stack S1 in which the optical thickness of the ORUs decrease monotonically in the minus-Z direction, while ORUs 4-6 may be grouped into another multilayer stack S2 in which the optical thickness of the ORUs increase monotonically. Such thickness profiles are helpful in producing sharpened spectral transitions. In contrast, thickness profiles of previously known films typically increase or decrease monotonically in only one direction. If desired for some applications, a discontinuity in optical thickness can be incorporated between the two stacks to give rise to a simple notch transmission band spectrum.

Other thickness gradients may be designed which improve peak transmission and make even steeper band edges (narrower transmission band). This can be achieved by arranging the individual layers into component multilayer stacks where one portion of the stacks has oppositely curved thickness profiles and the adjacent portions of the stacks have a slightly curved profile to match the curvature of the first portion of the stacks. The curved profile can follow any number of functional forms. The main purpose of the form is to break the exact repetition of thickness present in a quarter wave stack with layers tuned to only a single wavelength. The particular function used is an additive function of a linear profile and a sinusoidal function to curve the profile with an appropriate negative or positive first derivative. An important feature is that the second derivative of the ORU thickness profile be positive for the red (long wavelength) band edge of a reflectance stack and negative for the blue (short wavelength) band edge of a reflectance stack. The opposite sense is required if one refers to the band edges of the notched transmission band. Other embodiments incorporating the same principle include layer profiles that have multiple points with a zero value of the first derivative. In all cases here, the derivatives refer to those of a best fit curve fitted through the actual ORU optical thickness profile which can contain small statistical errors of less than 10% sigma, one standard deviation in optical thickness values.

The multilayer stack exiting the feedblock may then directly enter a final shaping unit such as a die. Alternatively, the stream may be split, preferably normal to the layers, to form two or more multilayer streams that may be recombined by stacking. The stream may also be split at an angle other than that normal to the layers. A flow channeling system that splits and stacks the streams is called a multiplier or interfacial surface generator (ISG). The width of the split streams can be equal or unequal. The multiplier ratio is defined by the ratio of the wider to narrower stream widths. Unequal streams widths (that is, multiplier ratios greater than unity) can be useful in creating layer thickness gradients. In the case of unequal streams, the multiplier should spread the narrower stream and/or compress the wider stream transversely to the thickness and flow directions to ensure matching layer widths upon stacking Many designs are possible, including those disclosed in U.S. Pat. Nos. 3,565,985; 3,759,647; 5,094,788; and 5,094,793 to Schrenk et al. In typical practice, the feed to a multiplier is rectangular in cross-section, the two or more split streams are also rectangular in cross-section, and rectangular cross-sections are retained through the flow channels used to re-stack the split streams. Preferably, constant cross-sectional area is maintained along each split stream channel, though this is not required.

Each original portion of the multilayer stack that exits the feedblock manifold, excluding PBLS, is known as a packet. In a film for optical applications, each packet is designed to reflect, transmit, or polarize over a given band of wavelengths. More than one packet may be present as the multilayer stack leaves the feedblock. Thus, the film may be designed to provide optical performance over dual or multiple bands. These bands may be separate and distinct, or may be overlapping. Multiple packets may be made of the same or of different combinations of two or more polymers. Multiple packets in which each packet is made of the same two or more polymers may be made by constructing the feedblock and its gradient plate in such a way that one melt train for each polymer feeds all packets, or each packet may be fed by a separate set of melt trains. Packets designed to confer on the film other non-optical properties, such as physical properties, may also be combined with optical packets in a single multilayer feedblock stack.

An alternative to creating dual or multiple packets in the feedblock is to create them from one feedblock packet via the use of a multiplier with multiplier ratio greater than unity. Depending on the bandwidth of the original packet and the multiplier ratio, the resulting packets can be made to overlap in bandwidth or to leave between them a bandwidth gap. It will be evident to one skilled in the art that the best combination of feedblock and multiplier strategies for any given optical film will depend on many factors, and must be determined on an individual basis.

Prior to multiplication, additional layers can be added to the multilayer stack. These outer layers perform as PBLs, but this time, within the multiplier. After multiplication and stacking, part of the PBL streams will form internal boundary layers between optical layers, while the rest will form skin layers. Thus the packets are separated by PBLs in this case. Additional PBLs can be added and additional multiplication steps may be accomplished prior to final feed into a forming unit such as a die. Prior to the final feed, additional layers can be added to the outside of the multilayer stack, whether or not multiplication has been performed, and whether or not PBLs have been added prior to the multiplication step. The additional layers form the final skin layers and the external portions of the earlier-applied PBLs will form sub-skins under these final skin layers. The die performs the additional compression and width spreading of the melt stream. Again, the die (including its internal manifold, pressure zones, etc.) is designed to create uniformity of the layer distribution across the web as it exits the die.

Skin layers are frequently added to the multilayer stack to protect the thinner optical layers from the effects of wall stress and possible resulting flow instabilities. Other reasons for adding a thick layer at the surface(s) of the film include, for example, surface properties such as adhesion, coatability, release, coefficient of friction, and barrier properties, weatherability, scratch and abrasion resistance, and others. In multilayer films that are subsequently uniaxially or very unequally biaxially drawn, “splittiness,” (that is, the tendency to tear or fail easily along the more highly drawn direction), can be substantially suppressed by choosing a skin layer polymer that (1) adheres well to the sub-skin or nearest optical layer polymer and (2) is less prone to orientation upon draw. An example of a useful skin layer, where the optical stack contains a PEN homopolyer, is a copolymer of PEN having comonomer content sufficient to suppress crystallinity and/or crystalline orientation. Marked suppression of splittiness is observed in such a structure, compared to a similar film without the coPEN skin layer(s), when the films are highly drawn in one planar direction and undrawn or only slightly drawn in the orthogonal planar direction. One skilled in the art will be able to select similar skin layer polymers to complement other optical layer polymers and/or sub-skin polymers.

Temperature control is important in the feedblock and subsequent flow leading to casting at the die lip. While temperature uniformity is often desired, in some cases, deliberate temperature gradients in the feedblock or temperature differences of up to about 40 degrees C. in the feed streams can be used to narrow or widen the stack layer thickness distribution. Feed streams into the PBL or skin blocks can also be set at different temperatures than the feedblock average temperature. Often, the PBL or skin streams are about 40 degrees C. higher than the feed stream temperature to reduce viscosity or elasticity in the protective streams and thus enhance their effectiveness as protective layers. Sometimes, the protective streams' temperature can be decreased up to about 40 degrees C. to improve the rheology matching between them and the rest of the flow stream. For example, decreasing the temperature of a low viscosity skin may enhance viscosity matching and enhance flow stability. Other times, elastic effects need to be matched.

Conventional means for heating the feedblock-multiplier-die assembly, namely, the use of insertion- or rod- or cartridge-type heaters fitted into bores in the assembly, can provide the temperature control required for the inventive optical films. Heat can also be provided uniformly from outside the assembly by (i) tiling its exterior with plate-type heaters, (ii) insulating thoroughly the entire assembly, or (iii) combining the two techniques. Plate-type heaters typically use a resistance-heating element embedded in a metal material, such as cast aluminum. Such heaters can distribute heat uniformly to an apparatus, such as, for example, the feedblock.

The use of insulation to control heat flow is not new. It is, however, typically not done in film extrusion due to the possibility of polymer melt leakage from the assembly onto the insulation. Because of the need to regulate layer flows very precisely, such leakage cannot be tolerated in the feedblock-multiplier-die assemblies used for the inventive optical films. Thus, feedblocks, multipliers, and dies are carefully designed, machined, assembled, connected, and maintained so as to prevent polymer melt leakage, and insulation of the assembly becomes both feasible and preferred.

An insertion- or rod- or cartridge-type heater (not shown), having both a specific design and specific placement within the feedblock, can be advantageous both for maintaining constant temperature in the feedblock and for creating a temperature gradient. Such heaters are well known in the art, and when used in conjunction with plate-type heaters, insulation, or both, can provide superior temperature control and/or uniformity to traditional means. Such superior control over layer thickness and gradient layer thickness distribution is especially important in controlling the positions and profiles of reflection bands as described in U.S. Pat. No. 6,157,490 (Wheatley et al.) entitled “Optical Film with Sharpened Bandedge” and U.S. application Ser. No. 09/006,591 entitled “Color Shifting Film,” both filed Jan. 13, 1998.

Shear rate is observed to affect viscosity and other rheological properties, such as elasticity. Flow stability sometimes appears to improve by matching the relative shape of the viscosity (or other rheological function) versus shear rate curves of the coextruded polymers. In other words, minimization of maximal mismatch between such curves may be an appropriate objective for flow stability. Thus, temperature differences at various stages in the flow can help to balance shear or other flow rate differences over the course of that flow.

The web is cast onto casting roll, sometimes referred to as a casting wheel or casting drum. The casting roll is preferably chilled to quench the web and begin the formation of a multilayer cast film. Preferably, casting is assisted by electrostatic pinning, the details of which are well-known in the art of polyester film manufacture. For the inventive optical films, care should be exercised in setting the parameters of the electrostatic pinning apparatus. Periodic cast web thickness variations along the extrusion direction of the film, frequently referred to as “pinning chatter,” should be avoided to the extent possible. Adjustments to the current, voltage, pinning wire thickness, and pinning wire location with respect to the die and the casting chill roll are all known to have an affect, and should be set on a case-by case basis by one skilled in the art.

The web can sometimes attain a sidedness in surface texture, degree of crystallinity, or other properties due to wheel contact on one side and merely air contact on the other. This can be desirable in some applications and undesirable in others. When minimization of such sidedness differences is desired, a nip roll can be used in combination with the casting roll to enhance quenching or to provide smoothing onto what would otherwise be the air side of the cast web.

In some cases, it is important that one side of the multilayer stack be the side chosen for the superior quench that is attained on the chill roll side. For example, if the multilayer stack consists of a distribution of layer thicknesses, it is frequently desired to place the thinnest layers nearest the chill roll. This is discussed in detail in U.S. Pat. No. 5,976,424 (Weber et al.), entitled “Method for Making Optical Films Having Thin Optical Layers,”.

In some cases, it is desired to provide the film with a surface roughness or surface texture to improve handling in winding and/or subsequent conversion and use. A specific example germane to the inventive optical films arises when they are intended for use in intimate contact with a glass plate or a second film. In such cases, selective “wetting out” of the optical film onto the plate or second film can result in the phenomenon known as “Newton's Rings,” which damages the uniformity of the optics over large surface areas. A textured or rough surface prevents the intimacy of contact required for wetting out thereby minimizing or eliminating the appearance of Newton's Rings.

It is well known in the polyester film art to include small amounts of fine particulate materials, often referred to as “slip agents,” to provide such surface roughness or texture. The use of slip agents can be incorporated into the inventive optical films. However, the inclusion of slip agent particulates can introduce a small amount of haze and can decrease the optical transmission of the film. In accordance with the present invention, Newton's Rings can be effectively prevented, without the use of slip agents, if surface roughness or texture is provided by contacting the cast web with a micro-embossing roll during film casting. Preferably, the micro-embossing roll will serve as a nip roll to the casting wheel. Alternatively, the casting wheel itself may be micro-textured to provide a similar effect. Further, both a micro-embossing casting wheel and a micro-embossing nip roll may be used together to provide a film that is micro-embossed on both sides.

Residence times in the various process stages may also be important even at a fixed shear rate. For example, interdiffusion between layers can be altered and controlled by adjusting residence times. “Interdiffusion,” as used in this document, refers to mingling and reactive processes between materials of the individual layers including, for example, various molecular motions such as normal diffusion, cross-linking reactions, or transesterification reactions. Sufficient interdiffusion is desirable to ensure good interlayer adhesion and prevent delamination. However, too much interdiffusion can lead to deleterious effects, such as the substantial loss of compositional distinctness between layers. Interdiffusion can also result in copolymerization or mixing between layers, which may reduce the ability of a layer to be oriented when drawn. The scale of residence time on which such deleterious interdiffusion occurs is often much larger (for example, by an order of magnitude) than that required to achieve good interlayer adhesion, thus the residence time can be optimized. However, some large-scale interdiffusion may be useful in profiling the interlayer compositions, for example to make rugate structures.

The effects of interdiffusion can also be altered by further layer compression. Thus, the effect at a given residence time is also a function of the state of layer compression during that interval relative to the final layer compression ratio. As thinner layers are more susceptible to interdiffusion, they are typically placed closest to the casting wheel for maximal quenching.

Applicants also found that interdiffusion can be enhanced after the multilayer film has been cast, quenched, and drawn, via heat setting at an elevated temperature. Heat setting is normally done in the tenter oven in a zone subsequent to the transverse drawing zone. Normally, for polyester films, the heat setting temperature is chosen to maximize crystallization rate and optimize dimensional stability properties. This temperature is normally chosen to be between the glass transition and melting temperatures, and not very near either temperature. Selection of a heat set temperature closer to the melting point of the lowest-melting polymer among those polymers in the multilayer film which are desired to maintain orientation in the final state results in a marked improvement in interlayer adhesion. This is unexpected due to the short residence times involved in heat setting on line, and the non-molten nature of the polymers at this process stage. Further, while off-line heat treatments of much longer duration are known to improve interlayer adhesion in multilayer films, these treatments also tend to degrade other properties, such as modulus or film flatness, which was not observed with on-line elevated-temperature heat setting treatments.

Conditions at the casting wheel are set according to the desired result. Quenching temperatures must be cold enough to limit haze when optical clarity is desired. For polyesters, typical casting temperatures range between 10 and 60 degrees C. The higher portion of the range may be used in conjunction with smoothing or embossing rolls while the lower portion leads to more effective quenching of thick webs. The speed of the casting wheel may also be used to control quench and layer thickness. For example, the extruder pumping rates may be slowed to reduce shear rates or increase interdiffusion while the casting wheel is increased in speed to maintain the desired cast web thickness. The cast web thickness is chosen so that the final layer thickness distribution covers the desired spectral band at the end of all drawing with concomitant thickness reductions.

The multilayer web is drawn to produce the final multilayer optical film. A principal reason for drawing is to increase the optical power of the final optical stack by inducing birefringence in one or more of the material layers. Typically, at least one material becomes birefringent under draw. This birefringence results from the molecular orientation of the material under the chosen draw process. Often this birefringence greatly increases with the nucleation and growth of crystals induced by the stress or strain of the draw process (for example stress-induced crystallization). Crystallinity suppresses the molecular relaxation, which would inhibit the development of birefringence, and crystals may themselves also orient with the draw. Sometimes, some or all of the crystals may be pre-existing or induced by casting or preheating prior to draw. Other reasons to draw the optical film may include, but are not limited to, increasing throughput and improving the mechanical properties in the film.

In one typical method for making a multilayer optical polarizer, a single drawing step is used. This process may be performed in a tenter or a length orienter. Typical tenters draw transversely (TD) to the web path, although certain tenters are equipped with mechanisms to draw or relax (shrink) the film dimensionally in the web path or machine direction (MD). Thus, in this typical method, a film is drawn in one in-plane direction. The second in-plane dimension is either held constant as in a conventional tenter, or is allowed to neck into a smaller width as in a length orienter. Such necking in may be substantial and increases with draw ratio. For an elastic, incompressible web, the final width may be estimated theoretically as the reciprocal of the square root of the lengthwise draw ratio times the initial width. In this theoretical case, the thickness also decreases by this same proportion. In practice, such necking may produce somewhat wider than theoretical widths, in which case the thickness of the web may decrease to maintain approximate volume conservation. However, because volume is not necessarily conserved, deviations from this description are possible.

In one typical method for making a multilayer mirror, a two step drawing process is used to orient the birefringent material in both in-plane directions. The draw processes may be any combination of the single step processes described that allow drawing in two in-plane directions. In addition, a tenter that allows drawing along MD, for example a biaxial tenter, which can draw in two directions sequentially or simultaneously, may be used. In this latter case, a single biaxial draw process may be used.

In still another method for making a multilayer polarizer, a multiple drawing process is used that exploits the different behavior of the various materials to the individual drawing steps to make the different layers comprising the different materials within a single coextruded multilayer film possess different degrees and types of orientation relative to each other. Mirrors can also be formed in this manner. Such optical films and processes are described further in U.S. Pat. No. 6,179,948 (Merrill et al.), filed Jan. 13, 1998 entitled “An Optical Film and Process for Manufacture Thereof.”

Drawing conditions for multilayer optical polarizer films are often chosen so that a first material becomes highly birefringent in-plane after draw. A birefringent material may be used as the second material. If the second material has the same sense of birefringence as the first (for example both materials are positively birefringent), then it is usually preferred to choose the second material so that it remains essentially isotropic. In other embodiments, the second material is chosen with a birefringence opposite in sense to the first material when drawn (for example, if the first material is positively birefringent, the second material is negatively birefringent). For a positively birefringent first material, the direction of highest in-plane refractive index, the first in-plane direction, coincides with the draw direction, while the direction of lowest in-plane refractive index for the first material, the second in-plane direction, is perpendicular to the first direction. Similarly, for multilayer mirror films, a first material is chosen to have large out-of-plane birefringence, so that the in-plane refractive indices are both higher than the initial isotropic value in the case of a positively birefringent material (or lower in the case of a negatively birefringent material). In the mirror case, it is often preferred that the in-plane birefringence is small so that the reflections are similar for both polarization states, that is a balanced mirror. The second material for the mirror case is then chosen to be isotropic, or birefringent in the opposite sense, in similar fashion to the polarizer case.

In another embodiment of multilayer optical films, polarizers may be made via a biaxial process. In still another embodiment, balanced mirrors may be made by a process that creates two or more materials of significant in-plane birefringence and thus in-plane asymmetry such that the asymmetries match to form a balanced result, for example nearly equal refractive index differences in both principal in-plane directions.

In certain processes, rotation of these axes can occur due to the effects of process conditions including tension changes down web. This is sometimes referred to as “bow-forward” or “bow-back” in film made on conventional tenters. Uniform directionality of the optical axes is usually desirable for enhanced yield and performance. Processes that limit such bowing and rotation, such as tension control or isolation via mechanical or thermal methods, can be used.

Frequently, it is observed that drawing film transverse to the machine direction in a tenter is non-uniform, with thickness, orientation, or both changing as the film approaches the gripped edges of the web. Typically, these changes are consistent with the assumption of a cooler web temperature near the gripped edges than in the web center. The result of such non-uniformity can be a serious reduction in usable width of the finished film. This restriction can be even more severe for the optical films of the present invention, as very small differences in film thickness can result in non-uniformity of optical properties across the web. Drawing, thickness, and color uniformity, as Applicants recognize, can be improved by the use of infrared heaters to heat further the edges of the film web near the tenter grippers. Such infrared heaters can be used before the tenter's preheat zone, in the preheat zone, in the stretch zone, or in a combination of locations. One skilled in the art will appreciate the many options for zoning and controlling the addition of infrared heat. Further, the possibilities for combining infrared edge heating with changes in the cast web's cross-web thickness profile will also be apparent.

For certain of the inventive multilayer optical films, it is desirable to draw the film in such a way that one or more properties, measured on the finished films, have identical values in the machine and transverse directions. Such films are often referred to as “balanced” films. Machine- and transverse-direction balance can be achieved by selecting process conditions using techniques well known in the art of biaxially oriented film making. Typically, process parameters explored include machine-direction orientation preheat temperature, stretch temperature, and draw ratio, tenter preheat temperature, tenter stretch temperature, and tenter draw ratio, and, sometimes, parameters related to the post-stretching zones of the tenter. Other parameters may also be significant. Typically, designed experiments are performed and analyzed to arrive at appropriate combinations of conditions. Those skilled in the art will appreciate the need to perform such an assessment individually for each film construction and each film line on which it is to be made.

Similarly, parameters of dimensional stability (such as shrinkage at elevated temperature and reversible coefficient of thermal expansion) are affected by a variety of process conditions. Such parameters include, but are not limited to, heat set temperature, heat set duration, transverse direction dimensional relaxation (“toe-in”) during heat set, web cooling, web tension, and heat “soaking” (or annealing) after winding into rolls. Again, designed experiments can be performed by one skilled in the art to determine optimum conditions for a given set of dimensional stability requirements, for a given film composition, and for a given film line.

In general, multilayer flow stability is achieved by matching or balancing the rheological properties, such as viscosity and elasticity, between the first and second materials to within a certain tolerance. The level of required tolerance or balance also depends on the materials selected for the PBL and skin layers. In many cases, it is desirable to use one or more of the optical stack materials individually in the various PBL or skin layers. For polyesters, the typical ratio between high and low viscosity materials is no more than 4:1, preferably no more than 2:1, and most preferably no more than 1.5:1 for the process conditions typical of feedblocks, multipliers, and dies. Using the lower viscosity optical stack material in the PBL and skin layers usually enhances flow stability. More latitude in the requirements for a second material to be used with a given first material is often gained by choosing additional materials for the PBL and skin layers. Often, the viscosity requirements of these third materials (PBL and skin layers) are then balanced with the effective average viscosities of the multilayer stack comprising the first and second materials. Typically, the viscosity of the PBL and skin layers should be lower than this stack average for maximal stability. If the process window of stability is large, higher viscosity materials can be used in these additional layers, for example, to prevent sticking to rollers downstream of casting in a length orienter.

Draw compatibility means that the second material can undergo the draw processing needed to achieve the desired birefringence in the first material without causing deleterious effects to the multilayer film, such as breakage, voiding, or stress whitening. These effects can cause undesired optical properties. Draw compatibility usually requires that the glass transition temperature of the second material be no more than about 40 degrees C. higher than that of the first material. This limitation can be ameliorated (1) by very fast drawing rates that make the orientation process for the first material effective even at higher temperatures or (2) by crystallization or cross-linking phenomena that also enhance the orientation of the first material at such higher temperatures. Also, draw compatibility requires that the second material can achieve the desired optical state at the end of processing, whether this is an essentially isotropic state or a highly birefringent state.

In the case of a second material that is to remain isotropic after final processing, at least three methods of material selection and processing can be used to meet this second requirement for draw compatibility. First, the second material can be inherently non-birefringent. An example of an inherently non-birefringent material is poly methylmethacrylate because it remains optically isotropic (as measured by refractive index) even if there is substantial molecular orientation after drawing. Second, the second material can be chosen so as to remain unoriented at the draw conditions of the first material, even though it could be made birefringent if drawn under different conditions. Third, the second material can orient during the draw process provided it may lose the orientation so gained in a subsequent process, such as a heat-setting step. In the case of multiple drawing schemes in which the final desired film contains more than one highly birefringent material (for example a polarizer made in certain biaxial drawing schemes), draw compatibility may not require any of these methods. Alternatively, the third method may be applied to achieve isotropy after a given drawing step, or any of these methods may be used for third or further materials.

Draw conditions can also be chosen to take advantage of the different visco-elastic characteristics of the first and second optical materials, as well as any materials used in the skin and PBL layers, such that the first material becomes highly oriented during draw while the second remains unoriented or only slightly oriented after draw according to the second scheme described above. Visco-elasticity is a fundamental characteristic of polymers. The visco-elasticity characteristics of a polymer may be used to describe its tendency to react to strain like a viscous liquid or an elastic solid. At high temperatures and/or low strain rates, polymers tend to flow when drawn like a viscous liquid with little or no molecular orientation. At low temperatures and/or high strain rates, polymers tend to draw elastically like solids with concomitant molecular orientation. A low temperature process is typically considered to take place near the polymeric material's glass transition temperature, while a high temperature process takes place substantially above the glass temperature.

Visco-elastic behavior is generally the result of the rate of molecular relaxation in a polymeric material. In general, molecular relaxation is the result of numerous molecular mechanisms, many of which are molecular weight dependent. Thus, polydisperse polymeric materials have a distribution of relaxation times, with each molecular weight fraction in the polydisperse polymer having its own longest relaxation time. The rate of molecular relaxation can be characterized by an average longest overall relaxation time (that is, overall molecular rearrangement) or a distribution of such times. The precise numerical value for the average longest relaxation time for a given distribution is a function of how the various times in the distribution are weighted in the average. The average longest relaxation time typically increases with decreasing temperature and becomes very large near the glass transition temperature. The average longest relaxation time can also be increased by crystallization and/or crosslinking in the polymeric material which, for practical purposes, inhibits any relaxation under process times and temperatures typically used. Molecular weight and distribution, as well as chemical composition and structure (for example, branching), can also effect the longest relaxation time.

The choice of resin strongly effects the characteristic relaxation time. Average molecular weight, MW, is a particularly significant factor. For a given composition, the characteristic time tends to increase as a function of molecular weight (typically as the 3 to 3.5 power of molecular weight) for polymers whose molecular weight is well above the entanglement threshold. For unentangled polymers, the characteristic time tends to increase as a weaker function of molecular weight. Because polymers below this threshold tend to be brittle when below their glass transition temperatures and are usually undesirable, they are not the principal focus here. However, certain lower molecular materials may be used in combination with layers of higher molecular weight as could low molecular weight rubbery materials above the glass transition, for example an elastomeric or tacky layer. Inherent or intrinsic viscosity, IV, rather than average molecular weight, is usually measured in practice. The IV varies as MW.sup..alpha. where.alpha. is the solvent dependent Mark-Houwink exponent. The exponent a increases with solubility of the polymer. Typical values of a might be 0.62 for PEN (polyethylene naphthalate) and 0.68 for PET (polyethylene terephthalate), both measured in solutions of 60:40 Phenol:ortho-Dichlorobenzene, with intermediate values for a copolymer of the two (for example, coPEN). PBT (polybutylene terephthalate) would be expected to have a still larger value of .alpha. than PET, as would polyesters of longer alkane glycols (for example hexane diol) assuming improved solubility in the chosen solvent. For a given polymer, better solvents would have higher exponents than those quoted here. Thus, the characteristic time is expected to vary as a power law with IV, with its power exponent between 3/.alpha. and 3.5/.alpha.. For example, a 20% increase in IV of a PEN resin is expected to increase the effective characteristic time. Thus the Weissenberg Number (as defined below) and the effective strength of the drawing flow, at a given process temperature and strain rate by a factor of approximately 2.4 to 2.8. Since a lower IV resin will experience a weaker flow, relatively lower IV resins are preferred in the present invention for the case of a second polymer of desired low final birefringence, and higher IV resins are preferable for the stronger flows required of the first polymer of high birefringence. The limits of practice are determined by brittleness on the low IV end and by the need to have adequate rheological compatibility during the coextrusion. In other embodiments, in which strong flows and high birefringence are desired in both a first and second material, higher IV may be desired for both materials. Other processing considerations, such as upstream pressure drops as might be found in the melt stream filters, can also become important. The severity of a strain rate profile can be characterized in a first approximation by a Weissenberg number (Ws) which is the product of the strain rate and the average longest relaxation time for a given material. The threshold Ws value between weak and strong draw (below which, and above which, the material remains isotropic or experiences strong orientation, crystallization and high birefringence, respectively) depends on the exact definition of this average longest relaxation time as an average of the longest relaxation times in the polydisperse polymeric material. It will be appreciated that the response of a given material can be altered by controlling the drawing temperature, rate and ratio of the process. A process which occurs in a short enough time and/or at a cold enough temperature to induce substantial molecular orientation is an orienting or strong draw process. A process which occurs over a long enough period and/or at hot enough temperatures such that little or no molecular orientation occurs is a non-orienting or weak process.

Although the present invention has been described with reference to preferred embodiments, workers skilled in the art will recognize that changes may be made in form and detail without departing from the spirit and scope of the invention.

Unless otherwise indicated, all numbers expressing feature sizes, amounts, and physical properties used in the specification and claims are to be understood as being modified by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

All references and publications cited herein are expressly incorporated herein by reference in their entirety into this disclosure, except to the extent they may directly contradict this disclosure. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

1. A feedblock for making a multilayered film, comprising:
a stack of shim subunits, each of the shim subunits including, in order:
a first layer shim having a first flow profile cutout and a first opening;
a first blocking shim having a second opening and a third opening;
a second layer shim having a second flow profile cutout and a fourth opening; and
a second blocking shim having a fifth opening and a sixth opening,
wherein each of the first flow profile cutout, the second opening, the fourth opening and the fifth opening are aligned to form a first manifold, and
further wherein each of the first opening, the third opening, the second flow profile cutout, and the sixth opening are aligned to form a second manifold separated from the first manifold.

2. The feedblock of claim 1, wherein the first flow profile cutout and the second flow profile cutout each comprise an exit orifice.

3. The feedblock of claim 2, wherein each of the exit orifices are aligned to form a feedblock exit aperture.

4-5. (canceled)

6. The feedblock of claim 1, wherein the first layer shim is a mirror image of the second layer shim.

7. The feedblock of claim 1, wherein at least one of the first layer shim, the second layer shim, the first blocking shim, and the second blocking shim comprise a die cut shim, a laser cut shim, a wire EDM cut shim, or a chemically etched cut shim.

8-10. (canceled)

11. The feedblock of claim 1, wherein each of the first layer shim, the second layer shim, the first blocking shim, and the second blocking shim further comprise alignment features.

12-14. (canceled)

15. The feedblock of claim 1, wherein the stack of shim subunits are held in compression.

16. The feedblock of claim 1, wherein at least one of the first layer shim and the first blocking shim or the second layer shim and the second blocking shim are bonded together.

17. The feedblock of claim 1, wherein the stack of shim subunits are bonded together to form a monolithic feedblock stack.

18. (canceled)

19. A multilayer film die, comprising:
a feedblock for making a multilayered film, including:
a stack of shim subunits, each of the shim subunits including, in order:
a first layer shim having a first flow profile cutout and a first opening;
a first blocking shim having a second opening and a third opening;
a second layer shim having a second flow profile cutout and a fourth opening; and
a second blocking shim having a fifth opening and a sixth opening,
wherein each of the first flow profile cutout, the second opening, the fourth opening and the fifth opening are aligned to form a first manifold, and
further wherein each of the first opening, the third opening, the second flow profile cutout, and the sixth opening are aligned to form a second manifold separated from the first manifold; and
an extrusion die having a die inlet aperture and a die lip, disposed so that the feedblock exit aperture is adjacent the die inlet aperture.

20. The multilayer film die of claim 19, further comprising a compression section disposed between the feedblock exit aperture and the inlet aperture.

21. The multilayer film die of claim 20, wherein the compression section further comprises a layer multiplier.

22. A feedblock for making a multilayered film, comprising:
a stack of shim subunits, each of the shim subunits including, in order:
a first layer shim having a first inlet and a first flow profile cutout;
a first blocking shim;
a second layer shim having a second inlet and a second flow profile cutout;
a second blocking shim; and
a gradient plate having a first manifold aligned to each first inlet, and a second manifold aligned to each second inlet,
wherein the first manifold and second manifold lack fluid communication.

23. The feedblock of claim 22, wherein the first flow profile cutout and the second flow profile cutout each comprise an exit orifice.

24. The feedblock of claim 23, wherein each of the exit orifices are aligned to form a feedblock exit aperture.

25-32. (canceled)

33. The feedblock of claim 22, wherein each of the first layer shim, the second layer shim, the first blocking shim, and the second blocking shim further comprise alignment features.

34-37. (canceled)

38. The feedblock of claim 22, wherein at least one of the first layer shim and the first blocking shim or the second layer shim and the second blocking shim are bonded together.

39. (canceled)

40. The feedblock of claim 22, wherein the stack of shim subunits are bonded together to form a monolithic feedblock stack.

41. (canceled)

42. A multilayer film die, comprising:
the feedblock of claim 22; and
an extrusion die having a die inlet aperture and a die lip, disposed so that the feedblock exit aperture is adjacent the die inlet aperture.

43. The multilayer film die of claim 42, further comprising a compression section disposed between the feedblock exit aperture and the inlet aperture.

44. The multilayer film die of claim 43, wherein the compression section further comprises a layer multiplier.
